(19) United States
(12) Patent Application Publication
(10) Pub. No.: US 2025/0060175 A1
(43) Pub. Date: Feb. 20, 2025

(54) Heat Exchangers, Methods of Using the Same, and Water Treatment Systems Containing Such Heat Exchangers

(71) Applicant: UGSI Solutions, Inc., Milpitas, CA (US)

(72) Inventors: Billie Fritz, Fremont, CA (US); Chris Levash, San Rafael, CA (US); Mark Kushman, Sunnyvale, CA (US); Len Todd, Milpitas, CA (US)

(21) Appl. No.: 18/807,475

(22) Filed: Aug. 16, 2024

Related U.S. Application Data
(60) Provisional application No. 63/520,499, filed on Aug. 18, 2023.

(51) Int. Cl. F28F 9/26; C09K 5/08; C25B 1/26; C25B 15/08; F28F 9/22

(52) U.S. Cl. CPC F28F 9/26; C09K 5/08; C25B 1/26; C25B 15/081; F28F 2009/224

(57) ABSTRACT

The present invention relates to a heat exchanger. The heat exchanger includes: a heat exchanger cartridge and a heat exchanger shell. The heat exchanger cartridge includes: a first end with a water inlet and outlet; a second closed end; a plurality of tubes that extend between the first end and the second end; and a plurality of baffles attached to one or more of the tubes. The heat exchanger shell includes: a hollow body with a first end having an opening for receiving the heat exchanger cartridge, and a second closed end; a hypochlorite inlet positioned at the first end; and a hypochlorite outlet positioned at the second end. The plurality of tubes can each independently have a length within a range of from 37 and 80 inches, and an inner diameter within a range of from 0.170 inches and 0.190 inches.

### CROSS-REFERENCE TO RELATED APPLICATIONS

This application claims the benefit of U.S. Provisional Patent Application No. 63/520,499, filed Aug. 18, 2023, the disclosure of which is incorporated herein by reference in its entirety.

### BACKGROUND OF THE INVENTION

### Field of the Invention

The present invention is generally directed to heat exchangers, methods of using heat exchangers, and water treatment systems containing such heat exchangers.

### Description of Related Art

Water utilities add disinfectants to water systems to prevent contamination from germs and bacteria. While chlorine compounds are the most common secondary disinfectant, and the traditional supply has been provided by bulk delivery of chemical to a utility, many water utilities are turning to chlorine generation systems that make compounds like sodium hypochlorite as the main secondary disinfectant. These hypochlorites are typically prepared on site to avoid issues associated with transportation and storage as these systems only require delivery of innocuous substances like salt to site.

When producing hypochlorites, DC power and salt water are typically used to create sodium hypochlorite, hydrogen gas, and heat. This process requires carefully calibrated parameters to run efficiently, including controlling the incoming water temperature. If the incoming water is below the desired temperature, a heat exchanger is commonly used to increase the temperature of the water.

While various types of heat exchangers are currently available, these heat exchangers do not have an optimal design that balances temperature difference, pressure loss, and flow rate to adapt to a water system's specific needs while also maximizing efficiency and performance. Thus, it is desirable to provide a heat exchanger that can be used in water treatment systems that addresses the drawbacks with current heat exchangers.

### SUMMARY OF THE INVENTION

In certain non-limiting embodiments or aspects, provided is a heat exchanger that includes: a heat exchanger cartridge and a heat exchanger shell. The heat exchanger cartridge includes: a first end comprising a water inlet and a water outlet; a second closed end opposite the first end; a plurality of tubes bundled together in a cylindrical pattern that extend between the first end and the second end; and a plurality of baffles in which each baffle is attached to one or more of the tubes, the plurality of baffles are spaced apart along the length of the plurality of tubes. The heat exchanger shell includes: a hollow body comprising a first end having an opening for receiving the heat exchanger cartridge, and a second closed end opposite the first end; a hypochlorite inlet positioned at the first end of the hollow body; and a hypochlorite outlet positioned at the second end of the hollow body. The plurality of tubes can comprise an amount of tubes within a range of from 18-52, and the plurality of tubes can each independently have a length within a range of from 37 and 80 inches, and an inner diameter within a range of from 0.170 inches and 0.190 inches. In certain non-limiting embodiments or aspects, the heat exchanger cartridge has a length within a range of from 41 and 85 inches. In some non-limiting embodiments, the plurality of tubes each independently have a length within a range of from 37 and 75 inches, and the heat exchanger cartridge has a length within a range of from 41 and 81 inches.

In certain non-limiting embodiments or aspects, the plurality of tubes each independently have an outer diameter within a range of from 0.240 inches and 0.260 inches.

In certain non-limiting embodiments or aspects, the hypochlorite inlet extends out from a side of the hollow body in a direction perpendicular to the opening at the first end of the heat exchanger shell. The hypochlorite outlet can also extend out from a side of the hollow body in a direction perpendicular to the second closed end of the heat exchanger shell and in a direction parallel to the hypochlorite inlet. In some non-limiting embodiments or aspects, the hypochlorite inlet and the hypochlorite outlet extend out from the same side of hollow body.

In certain non-limiting embodiments or aspects, the baffles are each independently attached to at least three tubes of the plurality of tubes. In some non-limiting embodiments or aspects, at least one of the baffles is positioned on a different side of the plurality of tubes than a second baffle. Further, the plurality of tubes of the heat exchanger cartridge can be formed from a metal, and the heat exchanger shell can be formed from a plastic.

In certain non-limiting embodiments or aspects, also provided is a method of heating water. The method can include: incorporating water into the plurality of tubes through the water inlet of the heat exchanger cartridge of the heat exchanger previously described and further described herein; incorporating hypochlorite into the heat exchanger shell through the hypochlorite inlet; heating the water flowing through the plurality of tubes by exchanging heat with the hypochlorite flowing through the heat exchanger shell; and releasing the heated water through the water outlet and releasing the hypochlorite through the hypochlorite outlet. The resulting water can be heated to a temperature above 55° F., and a pressure loss of the hypochlorite in the heat exchanger shell can be less than 0.2 psi.

In some non-limiting embodiments or aspects, the water and hypochlorite flow in opposite directions to provide a counter-current heat exchange. The hypochlorite can be sodium hypochlorite at a concentration of about 0.8%.

In certain non-limiting embodiments or aspects, further provided is a hypochlorite generation system. The system can include: a plurality of electrolytic cells in fluid communication with each other; and a heat exchanger previously described and further described herein positioned above the plurality of electrolytic cells.

In some non-limiting embodiments or aspects, the system further includes a piping system for distributing water into the heat exchanger when the temperature is below a desired temperature and for distributing water into the plurality of electrolytic cells when the temperature is at or above the desired temperature. The piping system can include a water inlet, a temperature gauge for determining a temperature of water entering through the water inlet, a heat exchanger water inlet in fluid communication with the heat exchanger, a heat exchanger water outlet in fluid communication with the heat exchanger, an electrolytic cell inlet in fluid communication with the plurality of electrolytic cells, and a plurality of valves. The plurality of valves can be configured to direct the water into the heat exchanger when the temperature is below a desired temperature and to bypass the heat exchanger to direct the water directly into the plurality of electrolytic cells when the temperature is at or above the desired temperature.

Additional preferred and non-limiting embodiments or aspects are set forth and described in the following clauses.

Clause 1: A heat exchanger comprising: (a) a heat exchanger cartridge comprising: a first end comprising a water inlet and a water outlet; a second closed end opposite the first end; a plurality of tubes bundled together in cylindrical pattern that extend between the first end and the second end; and a plurality of baffles attached to one or more of the plurality of tubes, the plurality of baffles spaces apart along the length of the plurality of tubes; and (b) a heat exchanger shell comprising: a hollow body comprising a first end having an opening for receiving the heat exchanger cartridge, and a second closed end opposite the first end; a hypochlorite inlet positioned at the first end of the hollow body; and a hypochlorite outlet positioned at the second end of the hollow body, wherein the plurality of tubes each independently have a length within a range of from 37 and 80 inches, and an inner diameter within a range of from 0.170 inches and 0.190 inches.

Clause 2: The heat exchanger of clause 1, wherein the hypochlorite inlet extends out from a side of the hollow body in a direction perpendicular to the opening at the first end of the heat exchanger shell.

Clause 3: The heat exchanger of clause 2, wherein the hypochlorite outlet extends out from a side of the hollow body in a direction perpendicular to the second closed end of the heat exchanger shell and in a direction parallel to the hypochlorite inlet.

Clause 4: The heat exchanger of any one of clauses 1-3, wherein the hypochlorite inlet and the hypochlorite outlet extend out from the same side of hollow body.

Clause 5: The heat exchanger of any one of clauses 1-4, wherein the baffles are each independently attached to at least three tubes of the plurality of tubes.

Clause 6: The heat exchanger of clause 5, wherein at least one of the baffles is positioned on a different side of the plurality of tubes than a second baffle.

Clause 7: The heat exchanger of any one of clauses 1-6, wherein the plurality of tubes of the heat exchanger cartridge are formed from a metal.

Clause 8: The heat exchanger of any one of clauses 1-7, wherein the heat exchanger shell is formed from a plastic.

Clause 9: The heat exchanger of any one of clauses 1-8, wherein the heat exchanger cartridge has a length within a range of from 41 and 85 inches.

Clause 10: The heat exchanger of any one of clauses 1-9, wherein the plurality of tubes each independently have a length within a range of from 37 and 75 inches, and the heat exchanger cartridge has a length within a range of from 41 and 81 inches.

Clause 11: The heat exchanger of any one of clauses 1-10, wherein the plurality of tubes each independently have an outer diameter within a range of from 0.240 inches and 0.260 inches.

Clause 12: The heat exchanger cartridge of any one of clauses 1-11, wherein the plurality of tubes comprise an amount of tubes within a range of from 18-52.

Clause 13: A method of heating water comprising: incorporating water into the plurality of tubes through the water inlet of the heat exchanger cartridge of the heat exchanger according to any one of clauses 1-12; incorporating hypochlorite into the heat exchanger shell through the hypochlorite inlet; heating the water flowing through the plurality of tubes by exchanging heat with the hypochlorite flowing through the heat exchanger shell; and releasing the heated water through the water outlet and releasing the hypochlorite through the hypochlorite outlet, wherein the water is heated to a temperature above 55° F., and wherein a pressure loss of the hypochlorite in the heat exchanger shell is less than 0.2 psi.

Clause 14: The method of clause 13, wherein the water and hypochlorite flow in opposite directions to provide a counter-current heat exchange.

Clause 15: The method of clauses 13 or 14, wherein the hypochlorite is sodium hypochlorite at a concentration of about 0.8%.

Clause 16: A hypochlorite generation system comprising: a plurality of electrolytic cells in fluid communication with each other; and a heat exchanger according to any one of clauses 1-12 positioned above the plurality of electrolytic cells.

Clause 17: The system of clause 16, further comprising a piping system for distributing water into the heat exchanger when the temperature is below a desired temperature and for distributing water into the plurality of electrolytic cells when the temperature is at or above the desired temperature.

Clause 18: The system of clause 17, wherein the piping system comprises a water inlet, a temperature gauge for determining a temperature of water entering through the water inlet, a heat exchanger water inlet in fluid communication with the heat exchanger, a heat exchanger water outlet in fluid communication with the heat exchanger, an electrolytic cell inlet in fluid communication with the plurality of electrolytic cells, and a plurality of valves.

Clause 19: The system of clause 18, wherein the plurality of valves are configured to direct the water into the heat exchanger when the temperature is below a desired temperature and to bypass the heat exchanger to direct the water directly into the plurality of electrolytic cells when the temperature is at or above the desired temperature.

### BRIEF DESCRIPTION OF THE DRAWINGS

FIG. 1 illustrates a perspective view of a heat exchanger cartridge of a heat exchanger according to the present disclosure;

FIG. 2 illustrates a second perspective view of a heat exchanger cartridge of a heat exchanger according to the present disclosure;

FIG. 3 is a front view of a first side of a heat exchanger cartridge of a heat exchanger according to the present disclosure;

FIG. 4 is a perspective view of a first side of a heat exchanger cartridge of a heat exchanger according to the present disclosure;

FIG. 5 is a front view of a faceplate with a plurality of holes on a first side of a heat exchanger cartridge of a heat exchanger according to the present disclosure;

FIG. 6 is a perspective view of a second side of a heat exchanger cartridge of a heat exchanger according to the present disclosure;

FIG. 7 is a back view of a second side with a plurality of holes of a heat exchanger cartridge of a heat exchanger according to the present disclosure;

FIG. 8 illustrates a side view of a heat exchanger cartridge of a heat exchanger according to the present disclosure;

FIG. 9 is an A-A top cross-sectional view of a first side of a heat exchanger cartridge of FIG. 8;

FIG. 10 is a B-B top cross-sectional view of a second side of a heat exchanger cartridge of FIG. 8;

FIG. 11 is a perspective view of a heat exchanger shell of a heat exchanger according to the present disclosure;

FIG. 12 is an exploded view of a heat exchanger according to the present disclosure;

FIG. 13 is a perspective view of a heat exchanger according to the present disclosure;

FIG. 14 is a top view of a heat exchanger according to the present disclosure;

FIG. 15 is a side view of a heat exchanger according to the present disclosure;

FIG. 16 is a perspective view of a hypochlorite generation system according to the present disclosure;

FIG. 17 is a perspective enlarged view of a heat exchanger on a hypochlorite generation system according to the present disclosure; and

FIG. 18 is a front enlarged view of a piping system for a hypochlorite generation system according to the present disclosure.

### DETAILED DESCRIPTION OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

Further, the terms “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume alternative variations and step sequences, except where expressly specified to the contrary. It is also to be understood that the specific devices and processes illustrated in the attached drawings, and described in the specification, are simply exemplary embodiments of the invention. Hence, specific dimensions and other physical characteristics related to the embodiments disclosed herein are not to be considered as limiting.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

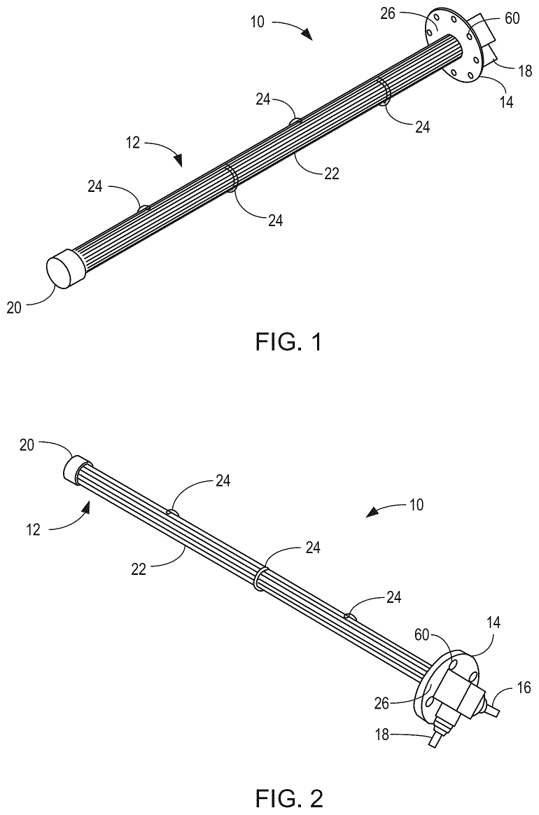

Referring to FIGS. 1-2, and in one preferred and non-limiting embodiment, the present disclosure is directed to a heat exchanger 10. The heat exchanger 10, with respect to the present disclosure, uses a temperature difference between fluids to drive heat into one of them. As further described herein, the heat exchanger 10 is capable of heating water for use in generating hypochlorites.

As shown in FIGS. 1-2, the heat exchanger 10 comprises a heat exchanger cartridge 12 that includes a first end 14 comprising a water inlet 16 and a water outlet 18, and a second closed end 20 opposite the first end 14. A plurality of tubes 22 are bundled together in a cylindrical pattern and extend between the first end 14 and the second end 20. As further shown in FIGS. 1-2, a plurality of baffles 24 are attached to one or more of the plurality of tubes 22. It is appreciated that each baffle can be attached to one or multiple tubes 22.

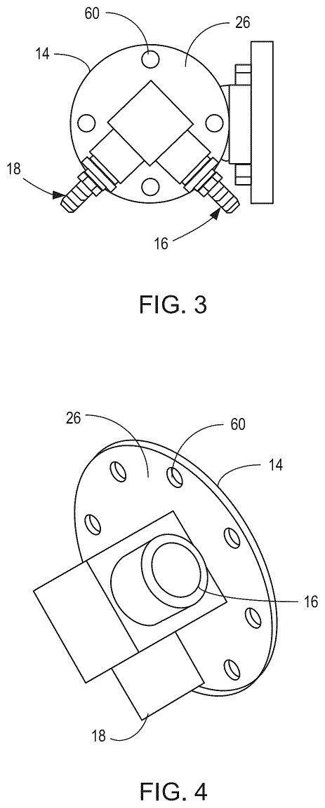

Referring to FIGS. 1-4, the water inlet 16 and water outlet 18 can be attached to a faceplate 26 that is in fluid communication with the plurality of tubes 22. The water inlet 16 and water outlet 18 can comprise various orientations with respect to each other. In one non-limiting embodiment or aspect, the water inlet 16 and water outlet 18 are orientated downwards from the longitudinal direction of the plurality of tubes 22 and which are at different angles to each other (i.e., the water inlet 16 and water outlet 18 extend down at different angles to each other). It will be appreciated that the water inlet 16 receives and directs incoming water into the plurality of tubes 22 to be heated, and the water outlet 18 directs heated water out of the plurality of tubes 22.

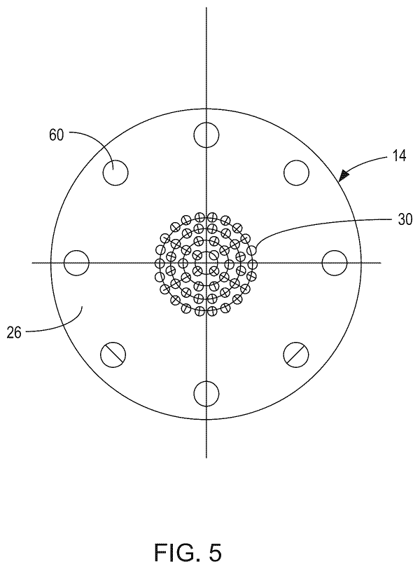

It will be appreciated that the first end 14 of the heat exchanger cartridge 12, such as in the faceplate 26, contains a plurality of holes 30, as shown in FIG. 5. A portion of the plurality of holes 30 are in fluid communication with the plurality of tubes 22 that receives incoming water flowing through the water inlet 16. The remaining tubes 22 are in fluid communication with different holes 30 where heated water flows out through the water outlet 18.

Referring again to FIG. 5, the holes 30 are configured to match the orientation of the tubes 22 at the first end 14. For instance, as shown in FIG. 5, the holes 30 have a cylindrical pattern with multiple cylindrical rows. The holes 30 and corresponding cylindrical rows can have various configurations to provide a desired flow through the tubes 22 as well as other properties. The various configurations can include, for example, certain curvatures of the different cylindrical rows of holes 30, sizes of the holes 30, angles between the holes 30 and corresponding patterns, and the like. FIG. 5 provides non-limiting examples of such design configurations.

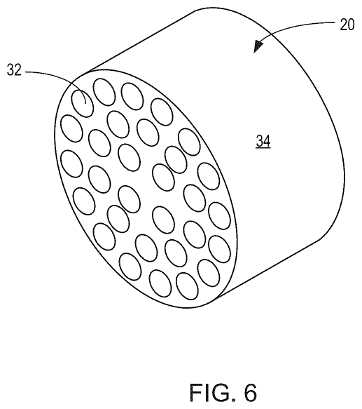

Referring to FIG. 6, the second end 20 of the heat exchanger cartridge 12 comprises a plurality of holes 32 configured to receive an opposite end of the plurality of tubes 22 extending from the first end 14. The second end 20 also comprises a chamber 34 that receives water flowing from the water inlet 16, which then flows out of the chamber 34 back toward the first end 14 and the water outlet 18. As such, in certain non-limiting embodiments or aspects, a portion of the plurality of tubes 22 are in fluid communication with the water inlet 16 and the second end 20, and the remaining plurality of tubes 22 are in fluid communication with the water outlet 18 and the second end 20.

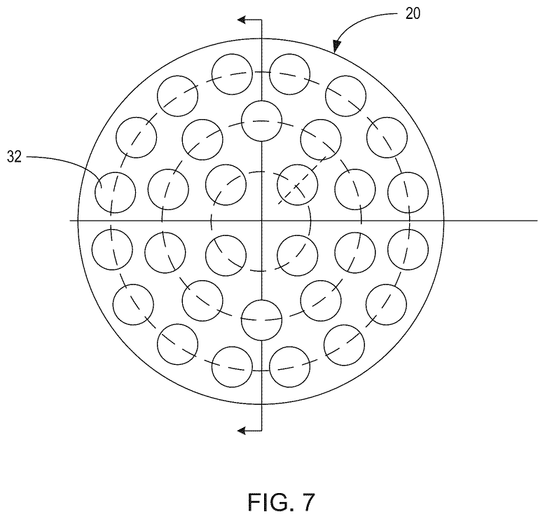

As shown in FIG. 7, the holes 32 are configured to match the orientation of the tubes 22 at the second end 20. For instance, the holes 32 can have a cylindrical pattern with multiple cylindrical rows. The holes 32 and corresponding cylindrical rows can also have various configurations to provide a desired flow through the tubes 22 as well as other properties. The various configurations can include, for example, certain curvatures of the different cylindrical rows of holes 32, sizes of the holes 32, angles between the holes 32 and corresponding patterns, and the like. FIG. 7 provides non-limiting examples of such design configurations.

As previously described, the heat exchanger cartridge 12 comprises a plurality of tubes 22 that are bundled together in a cylindrical pattern and extend between the first end 14 and the second end 20. The plurality of tubes 22 are configured to direct the flow of incoming water from the water inlet 16 to the second closed end 20 and then back to the water outlet 18 at the first end 14.

The previously described plurality of tubes 22 have various design parameters. In certain non-limiting embodiments or aspects, the plurality of tubes 22 each independently have a length within a range of from 37 and 80 inches with the heat exchanger cartridge 12 length being within a range of from 41 and 85 inches. In other non-limiting embodiments or aspects, the plurality of tubes 22 each independently have a length within a range of from 37 and 75 inches with the heat exchanger cartridge 12 length being within a range of from 41 and 81 inches. In yet other embodiments, the plurality of tubes 22 each independently have a length within a range of from 37 and less than 75 inches with the heat exchanger cartridge 12 length being within a range of from 41 and less than 81 inches. In a further embodiment, the plurality of tubes 22 each independently have a length within a range of from 37 and 67 inches with the heat exchanger cartridge 12 length being within a range of from 41 and 75 inches. It is appreciated that the heat exchanger cartridge 12 will be longer than the plurality of tubes 22.

The plurality of tubes 22 can also each independently have an outer diameter within a range of from 0.240 inches and 0.260 inches, such as about 0.251 inches. In addition, the plurality of tubes 22 can also each independently have an inner diameter within a range of from 0.170 inches and 0.190 inches, such as about 0.180 inches.

In certain non-limiting embodiments or aspects, the heat exchanger cartridge 12 comprises a number of tubes 22 within a range of from 18 and 52. As previously described, a portion of the plurality of tubes 22 are in fluid communication with the water inlet 16 and the second end 20, and the remaining plurality of tubes 22 are in fluid communication with the water outlet 18 and the second end 20. Accordingly, when the heat exchanger cartridge 12 comprises a number of tubes 22 within a range of from 18 and 52, tubes 22 extending in one flow direction are within a range of from 9-26 and tubes 22 extending in a different flow direction are within a range of from 9-26. It is appreciated that the number of tubes 22 extending in one flow direction can be the same or different than the number of tubes 22 extending in a different flow direction.

Other parameters of the tubes 22 can include designing the tangent-to-tangent distance between neighboring tubes 22. For example, the tangent-to-tangent distance between neighboring tubes 22 can be within a range of from 0.35 inches to 0.98 inches.

As previously noted, referring to FIGS. 1 and 2, baffles 24 are attached to the plurality of tubes 22. In some non-limiting embodiments or aspects, each baffle 24 is attached to at least three tubes 22. The baffles 24 can also be placed on the same or different sides of the plurality of tubes 22. For instance, at least one of the baffles 24 can be positioned on a different side of the plurality of tubes 22 than another baffle 24. It is appreciated that there can be one or multiple baffles 24, such as two or more, or three or more, baffles 24. In certain non-limiting embodiments or aspects, when multiple baffles 24 are used, every other baffle 24 can be on the same side of the plurality of tubes 22 such that consecutive baffles 24 are on different sides of the tubes 22.

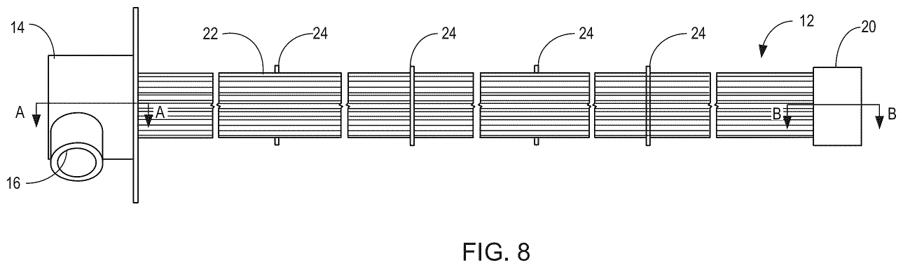

FIG. 8 further illustrates a side view of a heat exchange cartridge 12 as previously described. As shown in FIG. 8, the plurality of tubes 22 are welded together in a weldment design with baffles 24 positioned on different sides of the tubes 22. FIG. 8 illustrates a non-limiting embodiment where each consecutive baffle 24 is positioned on a different side of the plurality of tubes 22 and every other baffle 24 is positioned on the same side of the plurality of tubes 22. FIG. 8 further illustrates a non-limiting embodiment of the distance between each baffle 24, and between the baffles 24 and the first and second ends 14, 20.

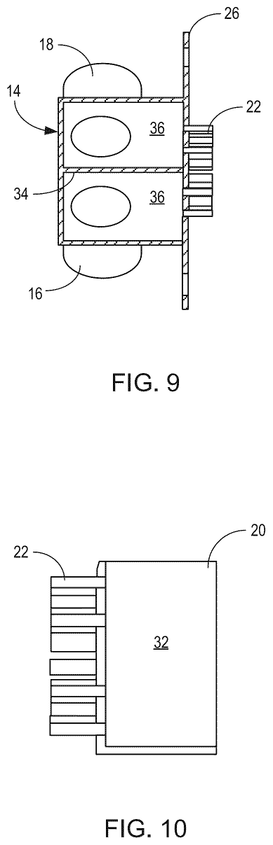

FIG. 9 is a top view of section A-A from FIG. 8. As shown in FIG. 9, in certain-non-limiting embodiments or aspects, water entering the water inlet 16 and water exiting through the water outlet 18 are separated by a partition 34 in a compartment 36 that directs incoming water into the tubes 22 and heated water exiting the tubes 22 to the water outlet 18. FIG. 10 is a top view of section B-B from FIG. 8. As shown in FIG. 10, in certain-non-limiting embodiments or aspects, the plurality of tubes 22 extend into the second closed end 20 where water flowing from the first end 14 enters compartment 32.

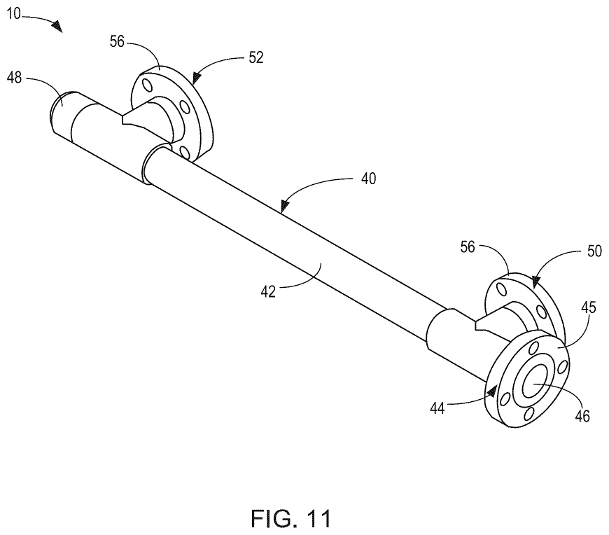

Referring to FIG. 11, the heat exchanger 10 further includes a heat exchanger shell 40. The heat exchanger shell 40 has a hollow body 42 comprising a first end 44 having an opening 46 for receiving the heat exchanger cartridge 12, and a second closed end 48, which is opposite the first end 44. As further shown in FIG. 11, the first end 44 of the hollow body 42 can comprise a faceplate 45. The faceplate 45 can have the same shape and dimensions as the faceplate 26 on the first end 14 of the heat exchanger cartridge 12.

As further shown in FIG. 11, the heat exchanger shell 40 also includes a hypochlorite inlet 50 positioned at the first end 44 of the hollow body 42, and a hypochlorite outlet 52 positioned at the second end 48 of the of the hollow body 42. In certain non-limiting embodiments, the hypochlorite inlet 50 can extend out from a side of the hollow body 42 in a direction perpendicular to the opening 46 at the first end 44 of the heat exchanger shell 40. Similarly, the hypochlorite outlet 52 can extend out from a side of the hollow body 42 in a direction perpendicular to the second closed end 48 of the heat exchanger shell 40. In some non-limiting embodiments or aspects, the hypochlorite inlet 50 and the hypochlorite outlet 52 extend out from the same side or different sides of the hollow body 42. The hypochlorite inlet 50 and the hypochlorite outlet 52 can also have faceplates 56 for attaching to other pipes.

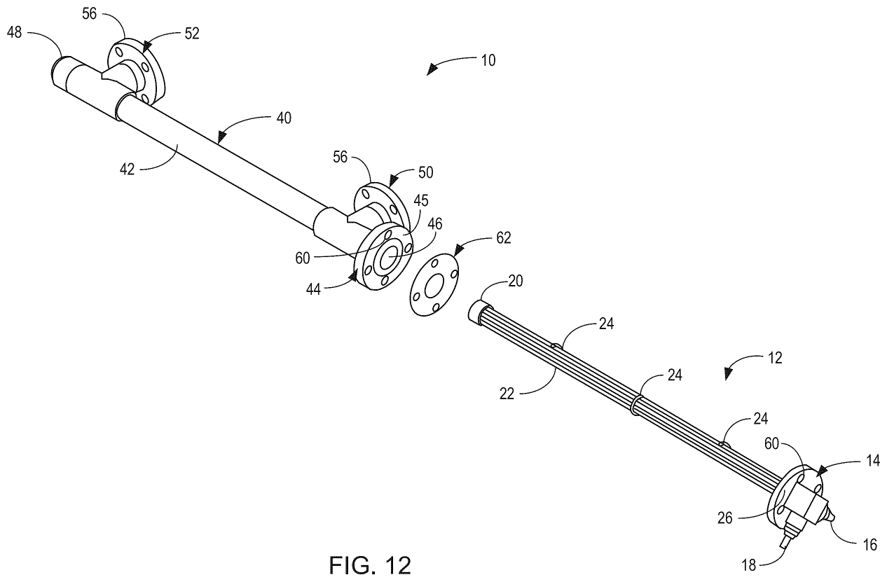

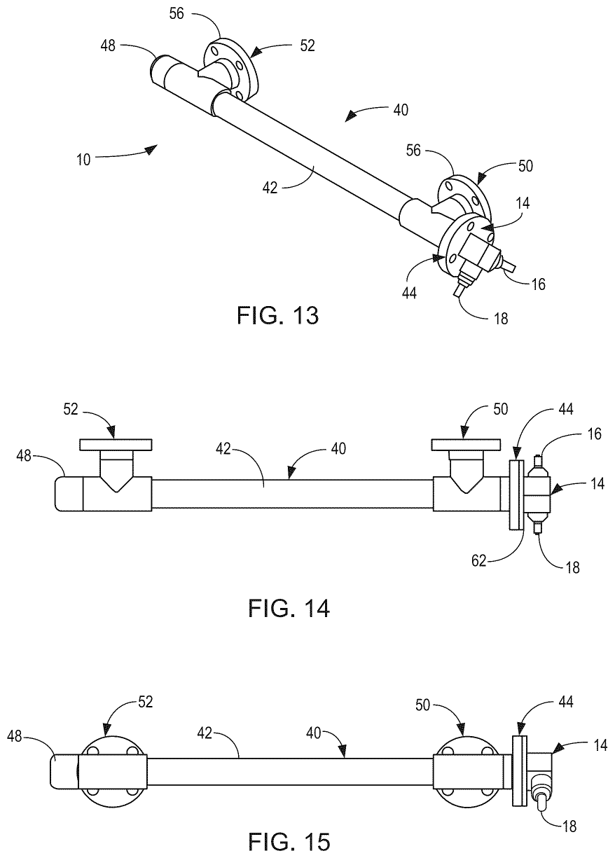

Referring to FIGS. 12-15, the heat exchanger cartridge 12 is configured to be inserted into the hollow body 42 of the heat exchanger shell 40. In certain non-limiting embodiments, the faceplate 45 on the first end 44 of the heat exchanger shell 40 can be attached to the faceplate 26 on the first end 14 of the heat exchanger cartridge 12. The faceplates 45, 26 can have orifices 60 where fasteners are inserted to secure the heat exchanger shell 40 to the heat exchanger cartridge 12. A gasket 62 can also be used in the attachment, as shown in FIG. 12.

The assembly of the heat exchanger cartridge 12 to the heat exchanger shell 40 to form the single unitary heat exchanger 10 is fast and non-labor intensive because the heat exchanger cartridge 12 is formed as a single-piece cartridge 12 that is easily inserted and attached to the single-piece shell 40.

It is appreciated that the various components of the heat exchanger 10 can be formed from one or more materials. For instance, in some non-limiting embodiments or aspects, the tubes 22 and/or the first and second ends 14, 20 can be formed from metal such as titanium, while the hollow body 42 of the shell 40 and baffles 24 can be formed from a plastic such as PVC or PVDF.

The present disclosure also includes a method of heating water using the previously described heat exchanger 10. The method can include incorporating water that needs to be heated into a portion of the plurality of tubes 22 from the water inlet 16 of the heat exchange cartridge 12, and incorporating hypochlorite into the heat exchanger shell 40 through the hypochlorite inlet 50. The hypochlorite can, for example, comprise sodium hypochlorite and at a particular concentration such as 0.8% for example.

As the water flows through the plurality of tubes 22 and the hypochlorite flows through the hollow body 42 of the heat exchanger shell 40 over the tubes 22, the heat from the hypochlorite is exchanged into the water, thereby heating the water in the tubes 22. The heated water flows out of the water outlet 18, and the hypochlorite flows to and out of the hypochlorite outlet 52.

In certain non-limiting embodiments or aspects, the water and hypochlorite flow in opposite directions to provide a counter-current heat exchange. For instance, during operation, water can flow into the water inlet 16 and corresponding tubes 22 toward the second closed end 20. The water then flows into and out of the chamber 34 back toward the first end 14 and the water outlet 18 through different tubes 22. At the same time, hypochlorite is flowing through the hollow body 42 of the shell 40 over the tubes 22 from the hypochlorite inlet 50 to the hypochlorite outlet 52. The water and hypochlorite can flow in different directions throughout the process as heat is exchanged.

The heat exchanger described herein 10 can allow for a desired flow rate of water and hypochlorite. For example, the water can flow through the plurality of tubes 22 within a range of from 0.7 to 24.3 gallons per minute, and the hypochlorite can flow through the shell 40 within a range of from 0.8 to 26.5 gallons per minute.

It was found that the heat exchanger 10 described herein can also heat the temperature of the water to above 55° F., such as between of 55° F. and 78° F., or within a range of from 60° F. to 65° F. While heating the water to the desired temperature, the heat exchanger 10 allows for a pressure loss of the hypochlorite in the heat exchanger shell 40 of less than 0.2 psi, such as less than 0.1 psi.

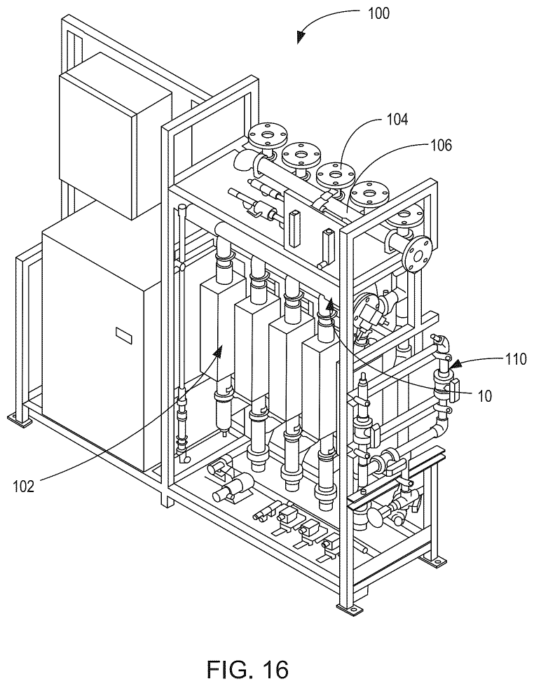

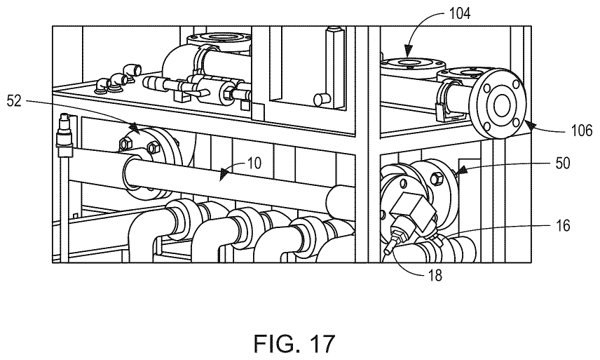

Referring to FIG. 16, the present disclosure further relates to a hypochlorite generation system 100 comprising a plurality of electrolytic cells 102 in fluid communication with each other, and the previously described heat exchanger 10. As shown in FIGS. 16-17, the heat exchanger 10 can be positioned above the plurality of electrolytic cells 102 with the hypochlorite outlet 52 in fluid communication with a hypochlorite outlet pipe 106. To prevent potential hazards, hydrogen formed through the system 100 is distributed out through outlets 104 positioned above the plurality of electrolytic cells 102. A non-limiting example of suitable electrolytic cells 102 is described in U.S. Pat. No. 7,897,022, which is incorporated by reference herein in its entirety.

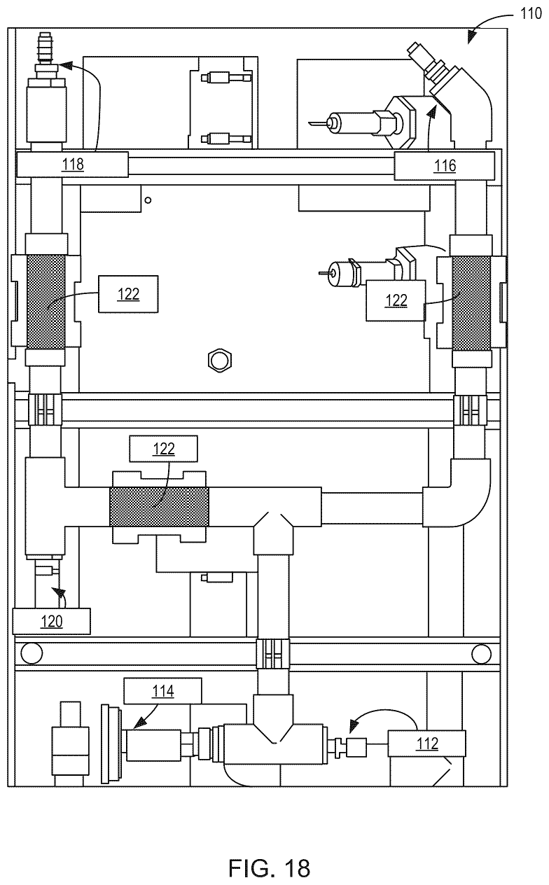

Referring to FIGS. 16 and 18, the system 10 can further comprise a piping system 110 for distributing water into the heat exchanger 10 when the temperature is below a desired temperature and for distributing water into the plurality of electrolytic cells 102 when the temperature is at or above the desired temperature. In certain non-limiting embodiments or aspects, the piping system 110 comprises a water inlet 112, a temperature gauge 114 for determining a temperature of water entering through the water inlet 112, a heat exchanger water inlet 116 in fluid communication with the heat exchanger 10, a heat exchanger water outlet 118 in fluid communication with the heat exchanger 10, an electrolytic cell inlet 120 in fluid communication with the plurality of electrolytic cells 102, and a plurality of valves 122.

In certain non-limiting embodiments or aspects, the plurality of valves 122 are configured to direct the water into the heat exchanger 10 when the temperature is below a desired temperature and to bypass the heat exchanger 10 to direct the water directly into the plurality of electrolytic cells 102 when the temperature is at or above the desired temperature. As such, the piping system 110 is designed to direct water to be heated into the heat exchanger 10 or to by-pass the heat exchanger 10 if the water is heated, such as being above 55° F.

Whereas particular embodiments of this invention have been described above for purposes of illustration, it will be evident to those skilled in the art that numerous variations of the details of the present invention may be made without departing from the invention as defined in the appended claims.

The invention claimed is:

1. A heat exchanger comprising:
(a) a heat exchanger cartridge comprising:
a first end comprising a water inlet and a water outlet;
a second closed end opposite the first end;
a plurality of tubes bundled together in a cylindrical pattern that extend between the first end and the second end; and
a plurality of baffles in which each baffle is attached to one or more of the plurality of tubes, the plurality of baffles spaced apart along a length of the plurality of tubes; and
(b) a heat exchanger shell comprising:
a hollow body comprising a first end having an opening for receiving the heat exchanger cartridge, and a second closed end opposite the first end;
a hypochlorite inlet positioned at the first end of the hollow body; and
a hypochlorite outlet positioned at the second end of the hollow body,
wherein the plurality of tubes each independently have a length within a range of from 37 and 80 inches, and an inner diameter within a range of from 0.170 inches and 0.190 inches.

2. The heat exchanger of claim 1, wherein the hypochlorite inlet extends out from a side of the hollow body in a direction perpendicular to the opening at the first end of the heat exchanger shell.

3. The heat exchanger of claim 2, wherein the hypochlorite outlet extends out from a side of the hollow body in a direction perpendicular to the second closed end of the heat exchanger shell and in a direction parallel to the hypochlorite inlet.

4. The heat exchanger of claim 3, wherein the hypochlorite inlet and the hypochlorite outlet extend out from the same side of hollow body.

5. The heat exchanger of claim 1, wherein the baffles are each independently attached to at least three tubes of the plurality of tubes.

6. The heat exchanger of claim 1, wherein at least one of the baffles is positioned on a different side of the plurality of tubes than a second baffle.

7. The heat exchanger of claim 1, wherein the plurality of tubes of the heat exchanger cartridge are formed from a metal.

8. The heat exchanger of claim 1, wherein the heat exchanger shell is formed from a plastic.

9. The heat exchanger of claim 1, wherein the heat exchanger cartridge has a length within a range of from 41 and 85 inches.

10. The heat exchanger of claim 1, wherein the plurality of tubes each independently have a length within a range of from 37 and 75 inches, and the heat exchanger cartridge has a length within a range of from 41 and 81 inches.

11. The heat exchanger cartridge of claim 1, wherein the plurality of tubes comprise an amount of tubes within a range of from 18-52.

12. The heat exchanger of claim 1, wherein the plurality of tubes each independently have an outer diameter within a range of from 0.240 inches and 0.260 inches.

13. A method of heating water comprising:
incorporating water into the plurality of tubes through the water inlet of the heat exchanger cartridge of the heat exchanger according to claim 1;
incorporating hypochlorite into the heat exchanger shell through the hypochlorite inlet;
heating the water flowing through the plurality of tubes by exchanging heat with the hypochlorite flowing through the heat exchanger shell; and
releasing the heated water through the water outlet and releasing the hypochlorite through the hypochlorite outlet,
wherein the water is heated to a temperature above 55° F., and wherein a pressure loss of the hypochlorite in the heat exchanger shell is less than 0.2 psi.

14. The method of claim 13, wherein the water and hypochlorite flow in opposite directions to provide a counter-current heat exchange.

15. The method of claim 13, wherein the hypochlorite is sodium hypochlorite at a concentration of about 0.8%.

16. A hypochlorite generation system comprising:
a plurality of electrolytic cells in fluid communication with each other; and
a heat exchanger according to claim 1 positioned above the plurality of electrolytic cells.

17. The system of claim 16, further comprising a piping system for distributing water into the heat exchanger when the temperature is below a desired temperature and for distributing water into the plurality of electrolytic cells when the temperature is at or above the desired temperature.

18. The system of claim 17, wherein the piping system comprises a water inlet, a temperature gauge for determining a temperature of water entering through the water inlet, a heat exchanger water inlet in fluid communication with the heat exchanger, a heat exchanger water outlet in fluid communication with the heat exchanger, an electrolytic cell inlet in fluid communication with the plurality of electrolytic cells, and a plurality of valves.

19. The system of claim 18, wherein the plurality of valves are configured to direct the water into the heat exchanger when the temperature is below a desired temperature and to bypass the heat exchanger to direct the water directly into the plurality of electrolytic cells when the temperature is at or above the desired temperature.
